(19) United States
(12) Patent Application Publication
(10) Pub. No.: US 2006/0123578 A1
(43) Pub. Date: Jun. 15, 2006

(54) Paint roller

(76) Inventor: Janet M. Rickstrew, Denver, CO (US)

Correspondence Address: ROBERT A. PARSONS, 4000 N. CENTRAL AVENUE, SUITE 1220, PHOENIX, AZ, 85012, US

(21) Appl. No.: 11/008,417

(22) Filed: Dec. 9, 2004

(51) Int. Cl. B05C 17/02

(52) U.S. Cl. 15/230.11; 15/144.1; 492/13; 492/19

(57) ABSTRACT

A device for holding a paint roller includes a first frame member having opposing first and second ends, a second frame member having opposing first and second ends, a handle attached to the first end of the first frame member, a mandrel mounted for rotation to the first end of the second frame member, and a joint coupling the second end of the first frame member to the second end of the second frame. The joint is adjustable between a disengaged/unlocked condition for selectively varying the angular displacement of the second frame member relative to the second frame member, and an engaged/locked condition for securing the second frame member relative to the first frame member.

### FIELD OF THE INVENTION

The present invention relates to paint rollers.

### BACKGROUND OF THE INVENTION

Paint rollers are useful for a variety of painting applications. Paint rollers are typically supported for rotation by a frame, which is coupled to an elongated handle. During painting operations it is frequently necessary to maneuver the frame in various orientations for the purpose of directing the paint roller against a surface to be painted. Maneuvering the frame often causes physical anatomical stress, and also entails moving the frame from hand to hand, which are aspects that are not at all satisfactory. Regardless of how the frame is maneuvered, it is often difficult to leverage the paint roller against a surface to be painted in all instances, which is not at all satisfactory.

### SUMMARY OF THE INVENTION

The above problems and others are at least partially solved and the above objects and others realized in a device for holding a paint roller which is easy to construct, which is inexpensive, which can be adjusted in various configurations for leveraging a paint roller attached to the frame against a surface to be painted, which has a mandrel for holding a conventional paint roller, which takes no specialized skill to use, and which can be easily disassembled for storage during periods of non-use.

According to the invention, there is provided a device for holding a roller for collecting and dispersing paint including a first frame member having opposing first and second ends, a second frame member having opposing first and second ends, a handle attached to the first end of the first frame member, a mandrel mounted for rotation to the first end of the second frame member, and a joint coupling the second end of the first frame member to the second end of the second frame, wherein the joint is adjustable between a disengaged/locked condition for selectively varying the angular displacement of the second frame member relative to the second frame member, and an engage/unlocked condition for securing the second frame member relative to the first frame member. The mandrel has a first end directed toward the first end of the second frame member, and an opposing second end. A counterweight is also provided, which is releasably engagable to the second end of the mandrel providing equalized weight distribution across the mandrel. In a preferred embodiment, a threaded fastener system is used to releasably attached the counterweight to the second end of the mandrel, which has an element thereof carried by the counterweight and a complemental element thereof carried by the second end of the mandrel. In a particular embodiment, a roller for collecting and dispersing paint is attached to the mandrel. Preferably, the handle is parallel to the mandrel. In another exemplary embodiment, the handle is angularly offset relative to the mandrel.

According to the invention, a device for holding a roller for collecting and dispersing paint includes a first frame member, a second frame member having a mandrel rotated thereto, a first fixture affixed to one of the first frame member and the second frame member, a second fixture affixed to the other of the first frame member and the second frame member, and a mechanism for engaging/mating the second fixture to the first fixture in a plurality of different orientations each corresponding to a different angular displacement of the second frame member relative to the first frame member. The mandrel has a first end directed toward the first frame member, and an opposing second end. A counterweight is also provided, which is releasably engagable to the second end of the mandrel providing equalized weight distribution across the mandrel. In a preferred embodiment, a threaded fastener system is used to releasably attached the counterweight to the second end of the mandrel, which has an element thereof carried by the counterweight and a complemental element thereof carried by the second end of the mandrel. In a particular embodiment, a roller for collecting and dispersing paint is attached to the mandrel. Preferably, the handle is parallel to the mandrel. In another exemplary embodiment, the handle is angularly offset relative to the mandrel. In an exemplary embodiment, the mechanism for engaging/mating the second fixture to the first fixture includes teeth carried by a face of the second fixture and complementing teeth carried by an opposing face of the first fixture. In another exemplary embodiment, the mechanism for mating the second fixture to the first fixture includes an engagement element carried the second fixture, and a plurality of complemental engagement elements carried by the first fixture each being an engagement point for the engagement element and defining a different angular displacement of the second frame member relative to the first frame member. The engagement element includes one of a male engagement element and a female engagement, and the complemental engagement elements each include the other of the male engagement element and the female engagement element. A biasing mechanism biases the male engagement toward the female engagement elements. A threaded fastener system is used to tighten the second fixture against the first fixture, which includes an element thereof carried by one of the first and second fixtures and a complemental element thereof carried by the other of the first and second fixtures.

In a device for holding a roller for collecting and dispersing paint including a frame having a first end, an opposing second end, a handle attached to the first end, and a rotating mandrel attached to the second end, improvements therein according to the invention includes a joint incorporated into the frame including a first fixture attached to a first portion of the frame, in which the first portion of the frame has the first end of the frame, and a second fixture attached to a second portion of the frame, in which the second portion of the frame has the second end of the frame. The improvements further include a mechanism for mating the second fixture to the first fixture in a plurality of different orientations each corresponding to a different angular displacement of the second frame member relative to the first frame member. The mandrel has a first end directed toward the first frame member, and an opposing second end. The improvements still further include a counterweight, which is releasably engagable to the second end of the mandrel providing equalized weight distribution across the mandrel. In a preferred embodiment, a threaded fastener system is used to releasably attached the counterweight to the second end of the mandrel, which has an element thereof carried by the counterweight and a complemental element thereof carried by the second end of the mandrel. In a particular embodiment, a paint roller is attached to the mandrel. Preferably, the handle is parallel to the mandrel. In another exemplary embodiment, the handle is angularly offset relative to the mandrel. In an exemplary embodiment, the mechanism for mating the second fixture to the first fixture includes teeth carried by a face of the second fixture and complementing teeth carried by an opposing face of the first fixture. In another exemplary embodiment, the mechanism for mating the second fixture to the first fixture includes an engagement element carried the second fixture, and a plurality of complemental engagement elements carried by the first fixture each being an engagement point for the engagement element and defining a different angular displacement of the second frame member relative to the first frame member. The engagement element includes one of a male engagement element and a female engagement, and the complemental engagement elements each include the other of the male engagement element and the female engagement element. A biasing mechanism biases the male engagement toward the female engagement elements. A threaded fastener system is used to tighten the second fixture against the first fixture, which includes an element thereof carried by one of the first and second fixtures and a complemental element thereof carried by the other of the first and second fixtures.

Consistent with the foregoing summary of preferred embodiments of the invention, and the ensuing disclosure, both of which are to be taken together, the invention also contemplates associated apparatus and method embodiments.

### BRIEF DESCRIPTION OF THE DRAWINGS

Referring to the drawings:

FIG. 1 is a perspective view of a paint roller constructed and arranged in accordance with the principle of the invention;

FIG. 2 is a top plan view of the paint roller of FIG. 1;

FIG. 3 is a fragmented side elevational view of the paint roller of FIG. 1 shown as it would appear in a downwardly angled orientation;

FIG. 4 is side elevational view of the paint roller frame of FIG. 1 shown as it would appear in a normal orientation;

FIG. 5 is a fragmented side elevational view of the paint roller frame of FIG. 1 shown as it would appear in an upwardly angled orientation;

FIG. 6 is an exploded perspective view of a joint of the paint roller of FIG. 1;

FIG. 7 is another exploded perspective view of the joint of FIG. 6;

FIG. 8 is a top plan view of an alternate embodiment of a paint roller constructed and arranged in accordance with the principle of the invention;

FIGS. 9 and 10 are vertical sectional views of an alternate embodiment of a joint for use with a paint roller in accordance with the principle of the invention;

FIGS. 10 and 11 are vertical sectional views of a further alternate embodiment of a joint for use with a paint roller in accordance with the principle of the invention;

FIGS. 13 and 14 are vertical sectional views of yet a further alternate embodiment of a joint for use with a paint roller in accordance with the principle of the invention;

FIGS. 15 and 15A are perspective views of yet still a further alternate embodiment of a joint for use with a paint roller in accordance with the principle of the invention, the joint including teeth carried by a fixture and complementing teeth carried by an opposing fixture;

FIG. 16 is an enlarged perspective view of one of the fixtures of the joint of FIGS. 15 and 15A;

FIG. 17 is a fragmented side elevational view of the joint of FIGS. 15 and 15A showing the teeth of one fixture meshingly interacting with the complementing teeth of the opposing fixture;

FIG. 18 is a perspective view of still another alternate embodiment of a joint for use with a paint roller in accordance with the principle of the invention;

FIG. 19 is a fragmented perspective view of a mandrel of the paint roller of FIG. 1 and a counterweight releasably engagable to the mandrel;

FIG. 20 is a sectional view taken along line 20-20 of FIG. 19; and

FIG. 21 is a fragmented perspective view of a roller shown as it would appear attached to the mandrel (not shown) of the paint roller of FIG. 1, and the counterweight of FIGS. 19 and 20 shown as it would appear attached to the mandrel.

### DETAILED DESCRIPTION OF A PREFERRED EMBODIMENT

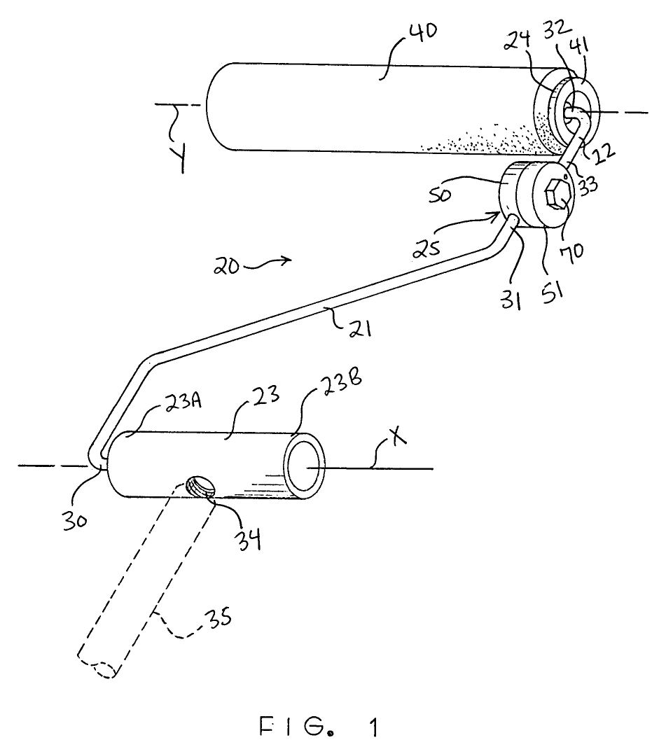

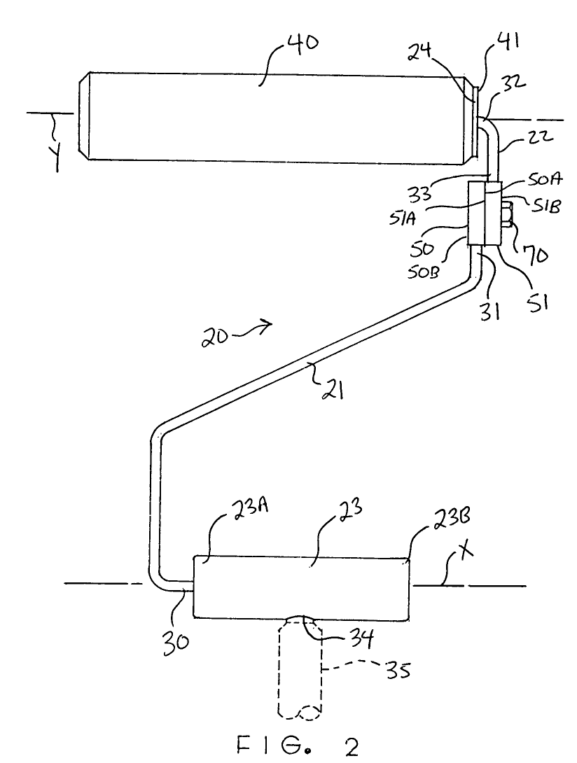

Turning now to the drawings, in which like reference characters indicate corresponding elements throughout the several views, attention is first directed to FIGS. 1 and 2 in which there is seen a paint roller 20 including frame members 21 and 22, a handle 23, a mandrel 24, and a joint 25. Frame members 21 and 22, including joint 25, are fashioned of steel, aluminum, plastic, or other substantially rigid material or combination of materials. Frame members 21 and 22 are elongate dowel-type components that have been bent or formed into their respective shapes as shown, in which frame member 21 is substantially longer than frame member 22. Frame member 21 has opposing ends 30 and 31, and frame member 22 has opposing ends 32 and 33. Handle 23 is attached to end 30 of frame member 21, and mandrel 24 is mounted for rotation to end 32 of frame member 22. Joint 25 couples frame member 21 to frame member 22, and is adjustable between a disengaged/unlocked condition for selectively varying the angular displacement/orientation of frame member 22 relative to frame member 21, and an engaged/locked condition for securing frame member 22 relative to frame member 21, in accordance with the principle of the invention. By adjusting the angular displacement/orientation of frame member 22 relative to frame member 22, the position of mandrel 24 relative to handle 23 can be adjusted. In this regard, the invention provides the adjustment of mandrel 24 relative to handle 23 for adjusting the leverage that can be applied to mandrel 24 from handle 23 while using paint roller 20 to apply paint to a surface, such as to the surface of a wall, ceiling, etc.

Handle 23 is the part of device 20 that is designed to be grasp and taken up by hand for wielding device 20. Handle 23 is an elongate member, which is fashioned of plastic, steel, aluminum, wood, or other substantially rigid material or combination of materials. Handle 23 has a proximal end 23A and an opposing distal end 23B. Proximal end 23A is affixed to end 30 of frame member 21 in a way like that of conventional paint rollers, such as by welding, gluing, a threaded fastening mechanism, with a nut and bolt assembly, etc.

Handle 23 is generally cylindrical in shape, and defines a central, longitudinal axis X therethrough from proximal end 23A to distal end 23B. Although handle 23 is generally cylindrical in shape, it can be made to take on other forms as may desired, including forms suitable for enhancing grip comfort, such as forms including formed finger grips and the like. Handle 23 can also be fashioned with exterior padding or rubber or rubber-like material for providing enhanced grip characteristics.

A threaded opening 34 is formed into handle 23 between proximal and distal ends 23A and 23B for threadably accepting a paint roller extension for providing increased reach of device 20 such as for painting ceilings and other hard-to-reach areas. The paint roller extension is illustrated in dotted outline and referenced at 35 in FIGS. 1 and 2.

Mandrel 24 is the part of paint roller 20 that is designed to accept and hold a conventional roller 40 for collecting and dispersing paint. Mandrel 24 has an end 41 that is mounted to end 32 of frame member 22 for rotation in a conventional manner like that of known paint rollers and an opposing end 42 shown in FIG. 19. Mandrel 24 defines a central, longitudinal axis Y, which is the axis of rotation of mandrel 24.

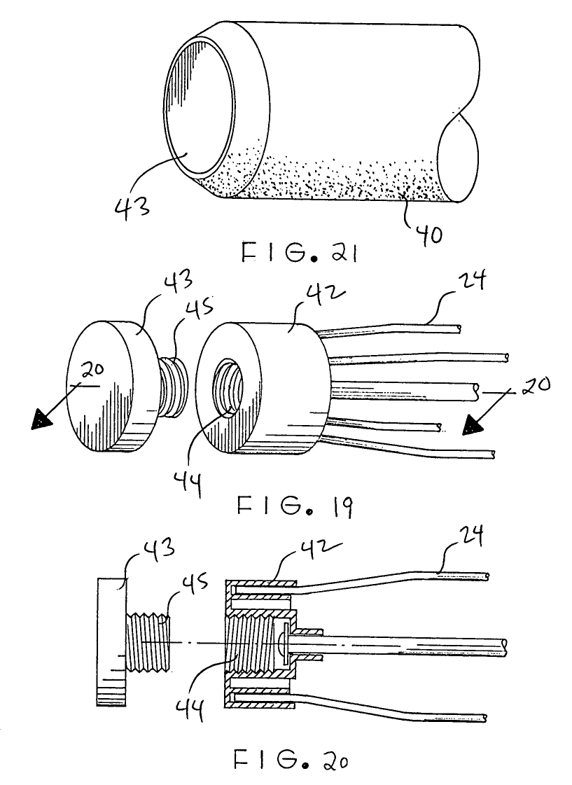

Momentary reference is now made to FIG. 19, which is a is a fragmented isometric view of mandrel 24 shown as it would appear with roller 40 (not shown in FIG. 19) detached therefrom. A counterweight 43 is releasably engagable to end 42 of mandrel 24, which, when attached to mandrel 24, equalizes the weight distribution across mandrel 24 relative to the remaining structure of paint roller 20. Looking also to FIG. 20, which is a sectional view taken along line 20-20 of FIG. 19, counterweight 43 shown disposed adjacent end 42 of mandrel 24, and a threaded fastener system is used to releasably secure counterweight 43 to end 42 of mandrel 24. The threaded fastener system includes a threaded female component or opening 44 formed into end 42 of mandrel 24, which threadably accepts a threaded male component 45 carried by counterweight 43, and this arrangement can be reversed, if desired. Other ways of releasably securing counterweight 43 to end 42 of mandrel 24 can be used without departing from the invention, such as a hook and loop fastening system, a detent fastening system, a snap fastening system, etc. The attachment of counterweight 43 to end 42 of mandrel 24 does not interfere with the attachment and removal of rollers to and from mandrel 24, and FIG. 21 is a fragmented perspective view of roller 40 shown as it would appear attached to mandrel 24 (not shown) and counterweight 43 shown as it would appear attached to end 42 (not shown) of mandrel 24.

Counterweight 43 is just that, namely, an equivalent weight for equalizing the weight distribution across mandrel 24 relative to the remaining structure of paint roller 20, including frame members 21 and 22, and joint 25. Counterweight 43 can be integrally formed, or fashioned of a plurality of attached parts. Counterweight 43 can be fashioned of steel, titanium, heavy plastic, a combination of the foregoing, etc. is a fragmented perspective view of a roller shown as it would appear attached to the mandrel (not shown) of the paint roller of FIG. 1, and the counterweight of FIGS. 19 and 20 shown as it would appear attached to the mandrel.

In the immediate embodiment, handle 23 is parallel to mandrel 24, in which axis X of handle 23 is parallel to axis Y of mandrel 24. When roller 40 is attached to mandrel 24 as in FIG. 1, paint roller 20 is provided. When a roller is not installed onto mandrel 24, it will be understood that the remaining structure, including frame members 21 and 22, handle 23, mandrel 24, and joint 25, constitute a device for holding a roller for collecting and dispersing paint, in accordance with the principle of the invention.

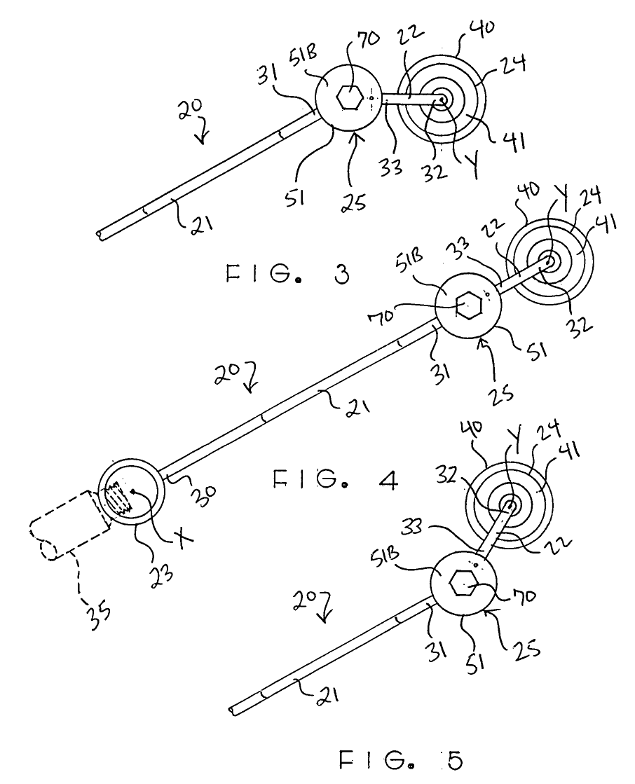

As previously explained, joint 25 couples frame member 21 to frame member 22, and is used to change the angular displacement/orientation of frame member 22 relative to frame member 21, and thus the position of mandrel 24 relative to handle 23. As a matter of example of different displacements of frame member 22 relative to frame member 21, reference is now made to FIGS. 3-5. In FIG. 3, frame member 22 is angled upwardly relative to frame member 21, and in FIG. 5 frame member 22 is angled downwardly relative to frame member 21. In FIG. 4, frame member 22 is normal relative to frame member 21.

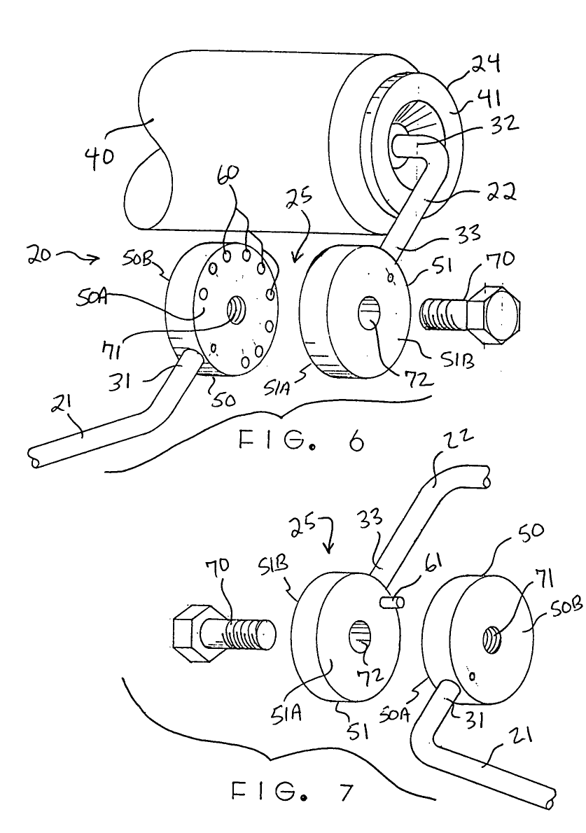

Referring to FIG. 6, joint 25 consists of a fixture 50 rigidly affixed to end 31 of frame member 21, and a fixture 51 rigidly affixed to end 33 of frame member 22. Fixtures 50 and 51 are each affixed to ends 31 and 33, respectively, with welding, a threaded fastener system, by pinning, press-fitting, etc. Fixtures 50 and 51 are generally circular disks, and are substantially coextensive relative to one another. Fixture 50 has opposing inner and outer major faces 50A and 50B, and fixture 51 has opposing inner and outer major faces 51A and 51B. Inner faces 50A and 51A confront and face one another. Fixtures 50 and 51 are capable of being engaged together securing frame member 21 to frame member 22, and disengaged from one another permitting adjustment of the angular displacement of frame member 22 relative to frame member 21.

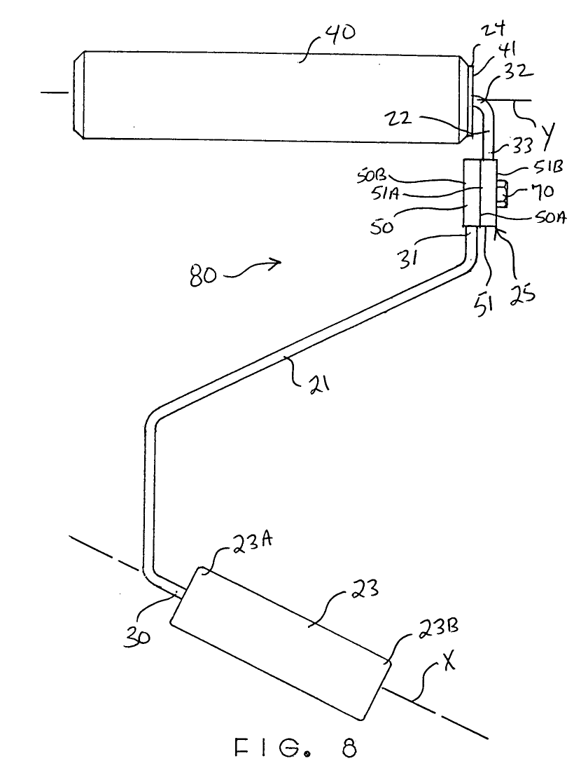

With continuing reference to FIG. 6, a parametric row of openings or recesses 60 is formed into inner face 50A of fixture. Looking to FIG. 7, a pin 61 is rigidly affixed to and projects outwardly from inner face 51A of fixture 51. Pin 61 can be welded to fixture 51, pinned to fixture 51, press fit to fixture 51, screwed onto fixture, etc. Recesses 60 are each sized to accept pin 61.

To engage fixture 51 to fixture 50, inner face 51A of fixture 51 is directed toward inner face 50A of fixture 50. Pin 61 is aligned with one of recesses 60, and inner faces 50A and 51A are brought together presenting pin 61 into the recess 60 it is aligned with. By engaging pin 61 with one of recesses 60, fixture 51 is engaged/locked to fixture 50, in which the interaction of pin 61 with the recess 60 to which it is engaged functions to prevent fixture 51 from rotating relative to fixture 50.

Recesses 60 each define an engagement point for pin 61, and a different angular orientation or displacement of frame member 22 relative to frame member 21. The engagement points for pin 61 defined by recesses 60 allow frame member 22 to be positioned normal relative to frame member 21 as shown in FIG. 4, positioned in each of a plurality of incrementally-different downwardly angled orientations relative to frame member 21 off of the normal orientation, and positioned in each of a plurality of incrementally-different upwardly angled orientations relative to frame member 21 off of the normal orientation. Any number of recesses 60 can be used for defining the desired number of engagement points for pin 61. The spacing between recesses 60 is predetermined. The spacing between recesses 60 provides five-degree incremental changes in the orientation of frame member 22 relative to frame member 21 in a preferred embodiment. However, the spacing between recesses 60 can be any desired spacing for providing selectively desired incremental engagement points for pin 61 and a corresponding degree change of adjustment of frame member 22 relative to frame member 21.

It is to be understood that each recess 60 is a female engagement feature, and pin 61 is a male engagement feature. Although one pin 61 is provided with fixture 51, more can be used, if desired. Also, although recesses 50 are carried by fixture 50 and pin 61 is carried by fixture 51, this can be reversed. Also, although the instant embodiment incorporates a plurality of recesses 60 and a corresponding pin 61, this can be reversed for providing a plurality of pins and one or more corresponding recess.

Joint 25 incorporates a threaded fastener system for rigidly securing fixture 51 to fixture 50 after fixtures 50 and 51 are engaged to one another, in accordance with the principle of the invention. In the embodiment depicted in FIGS. 6 and 7, this threaded fastener system includes a threaded bolt 70 carried by fixture 51 and a threaded bore 71 carried by fixture 50. Threaded bore 71 is formed into fixture 50 and passes through fixture 50 from inner face 50A to outer face 51B, and is centrally located. Bolt 70 extends through a central bore 72 through fixture 51, and is threadably accepted by threaded bore 71. Fixtures 50 and 51 are secured together by tightening bolt 70. Reversing this operation unsecures fixture 51 from fixture 50. Fixtures 50 and 51 can then be moved apart disengaging pin 61 from one recesses 60, in which fixture 51 can then be rotated relative to fixture 50 in order to align pin 61 with a different one of recesses 60 for providing a different angular orientation/displacement of frame member 22 relative to frame member 21. After pin 61 is aligned with a new recess 60, fixtures 50 and 51 can be moved together presenting pin 61 into the new recess, and then secured together by re-tightening bolt 70.

Although the threaded fastener system includes threaded bolt 70 carried by fixture 51 and threaded bore 71 carried by fixture 50, this arrangement can be reversed. Furthermore, other mechanisms suitable for rigidly securing fixture 51 to fixture 50 can be used, if desired, such as a lever assembly, a cammed lever assembly, a clamp mechanism, etc.

Referring now to FIG. 8, there is seen a top plan view of an alternate embodiment of a paint roller 80 constructed and arranged in accordance with the principle of the invention. Paint roller 80 includes frame members 21 and 22, handle 23, mandrel 24, roller 40, and joint 25. Paint roller 80 is substantially identical to paint roller 20, and the foregoing discussion of paint roller 20 applies to paint roller 80. Paint roller 80 differs from paint roller 20 in only one respect. As shown in FIG. 8, handle 23 is angularly offset relative to mandrel 24, in which axis X of handle 23 is angularly offset relative to axis Y of mandrel 24. The angular offset of handle 23 relative to mandrel 24 provides enhanced wrist comfort for a user grasping handle 23. Preferably, axis X angled outwardly approximately 30 degrees from axis Y, although other desired angular orientations can be used for handle 23 in order to provide the desired degree of wrist comfort.

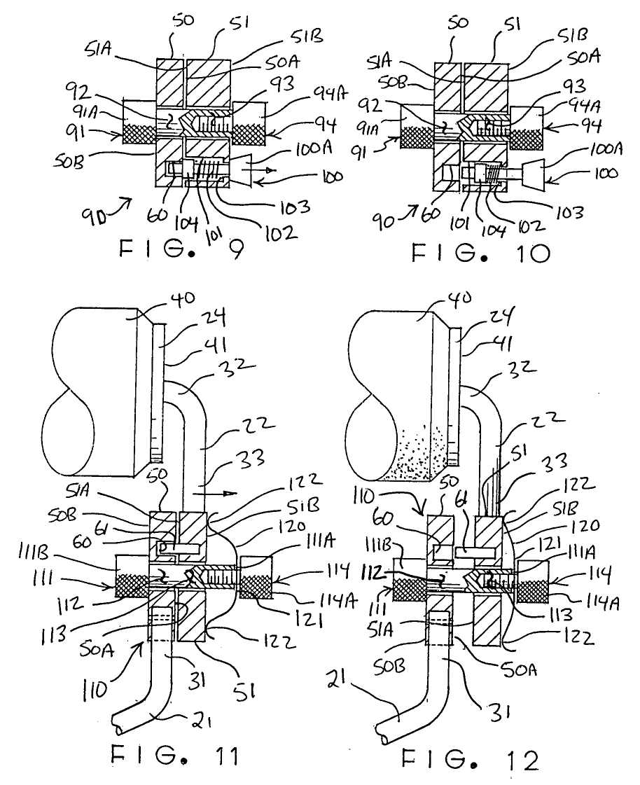

Joint 25 is preferred in that it is simple to construct, efficient, and inexpensive. Other joint forms capable of functioning in a manner consistent with that of joint 25 can be used with the invention without departing from the nature and scope of the invention. FIGS. 9-18 show examples of other joint forms.

FIGS. 9 and 10 are vertical sectional views of a first alternate embodiment of a joint designated generally at 90, including fixture 50, and fixture 51. Fixture 50 incorporates recesses 60, in which only one is shown in FIGS. 9 and 10. A headed, internally-threaded rivet 91 extends into and through central bores 92 and 93 through fixtures 50 and 51, respectively, which is threadably secured to a threaded bolt 94. Bores 92 and 93 are coaxial. A head 91A of rivet 91 is positioned against outer face 50B of fixture 50, and a head 94A of threaded bolt 94 is positioned against outer face 51B of fixture 51, in which fixtures 50 and 51 encircle rivet 91 and are captured between heads 91A and 94A. Rivet 91 and threaded bolt 94 function as a pin pinning fixtures 50 and 51 together, in which fixtures 50 and 51 are able to rotate relative to, or thereabout, rivet 91.

Fixture 51 supports a spring-loaded pin 100. Pin 100 is positioned through a bore 101 formed through fixture 51 from inner face 51A to outer face 51B. A spring 102 is located in bore 101, encircles pin 100, and interacts against an endwall 103 of bore 101 and an enlargement 104 carried by pin 100 biasing pin 100 toward fixture 50 and, moreover, toward recesses 60 of fixture 50. Spring 102 is a compression spring. Pin 100 has a head 100A located outboard of outer face 51B. By taking up head 10A, such as by hand, a forcible pulling impulse sufficient to overcome the bias applied to pin 100 by spring 102 can be applied to pin 100. In this way, pin 100 can be pulled and moved outwardly or away from fixture 50 disengaging pin 100 from the recess 60 as shown in FIG. 10. At this point, fixture 51 can be rotated about rivet 91 to align pin 100 with another recess, and then released allowing spring 102 to bias pin 100 into the new recess. This operation is repeated as needed. Also, although fixture 51 carries pin and fixture 50 carries recesses 60, this can be reversed.

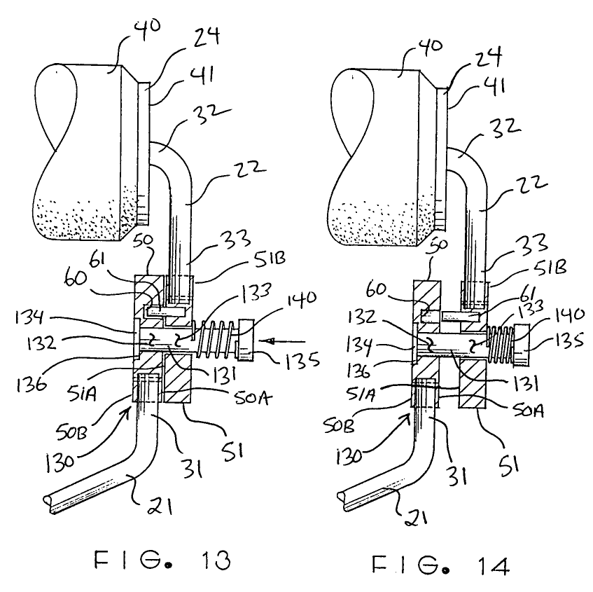

FIGS. 11 and 12 are vertical sectional views of another embodiment of a joint designated generally at 110, including fixture 50, and fixture 51. Fixture 50 incorporates recesses 60, in which only one is shown in FIGS. 11 and 12. Fixture 51 incorporates pin 61. A headed, internally-threaded rivet 111 extends into and through central bores 112 and 113 through fixtures 50 and 51, and has an end 111A located outboard of outer face 51A of fixture 51 to which a threaded bolt 114 is threadably secured. Bores 112 and 113 are coaxial. A head 111B of rivet 111 is positioned against outer face 50B of fixture 50, and a head 114A of threaded bolt 114 is positioned against outer face 51B of fixture 51. Rivet 111 and threaded bolt 114 function as a pin pinning fixtures 50 and 51 together, in which fixtures 50 and 51 are able to rotate relative to, or thereabout, rivet 114, and also reciprocate relative to rivet 114. Rivet 114 can be rigidly affixed to fixture 50 and, moreover, to bore 113, if desired.

An elongate flexural spring 120 is captured between head 114A of threaded bolt 114 and outer face 51B of fixture. In this embodiment, spring 120 is an elongate, generally U-shaped component having an intermediate portion 121 and opposing free ends 122. Spring 120 is fashioned of spring steel or other material having shape memory. Threaded bolt 114 extends through an opening through intermediate portion 121, intermediate portion 121 is captured between head 114A and end 111A of rivet 111, and free ends 122 are directed against outer face 51A of fixture 51 on either side thereof.

Spring 120 acts on head 114 and outer face 51A of fixture 51 biasing fixture 51 to toward fixture 50 and, moreover, pin 61 toward recesses 60. By taking up fixtures 50 and 51, such as by hand, a forcible impulse sufficient to overcome the bias applied by spring 120 can be applied for moving fixtures 50 and 51 apart and disengaging pin 61 from the recess 60 as shown in FIG. 12. At this point, fixture 51 can be rotated to align pin 61 with another recess, and then released allowing spring 120 to force fixtures 50 and 51 together engaging pin 61 with the new recess. This operation is repeated as needed. Also, although fixture 50 carries recesses 60 and fixture carries pin 61 in connection with joint 110, this can be reversed is previously explained.

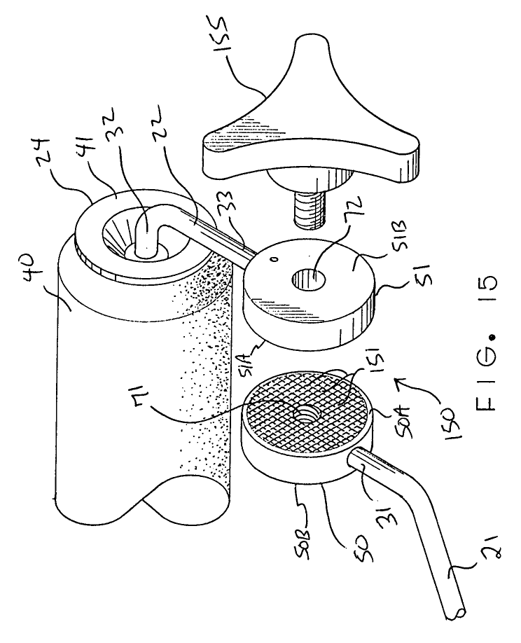

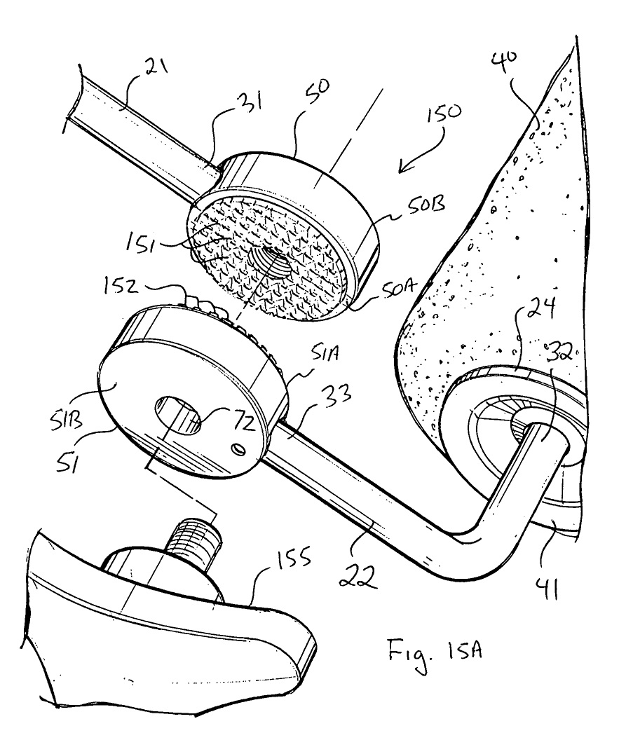

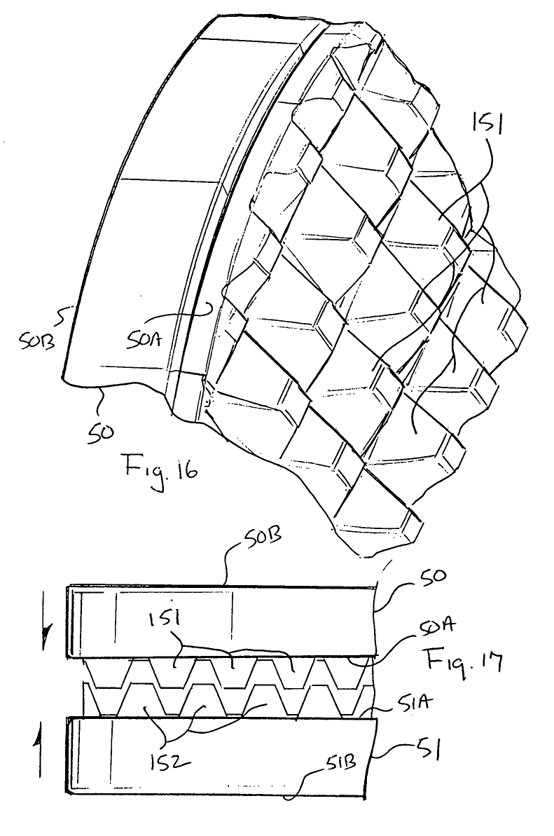

FIGS. 13 and 14 are vertical sectional views of yet another embodiment of a joint designated generally at 130, including fixture 50, and fixture 51. Fixture 50 incorporates recesses 60, in which only one is shown in FIGS. 13 and 14. Fixture 51 incorporates pin 61. A pin 131 extends into and through central bores 132 and 133 through fixtures 50 and 51, and has an end 131A located outboard of outer face 51A of fixture 51, and an opposing end 131B. Bores 132 and 133 are coaxial. Heads 134 and 135 are affixed to ends 131A and 131B, respectively. Head 134 of rivet 131 is positioned in a recess 136 formed into outer face 50B of fixture 50. Pin 131 pins fixtures 50 and 51 together, in which at least fixtures 51 is able to rotate thereabout, and reciprocate relative thereto. Preferably, pin 131 is rigidly affixed to fixture 50 and, moreover, to bore 132.

A compression spring 140 encircles pin 131 and is captured by and between head 135 of pin 131 and outer face 51A of fixture 51. Spring 140 acts on head 135 and outer face 51A of fixture 51 biasing fixture 51 toward fixture 50 and, moreover, pin 61 toward recesses 60. By taking up fixtures 50 and 51, such as by hand, a forcible impulse sufficient to overcome the bias applied by spring 140 can be applied for moving fixtures 50 and 51 apart and disengaging pin 61 from the recess 60 as shown in FIG. 14. At this point, fixture 51 can be rotated to align pin 61 with another recess, and then released allowing spring 140 to force fixtures 50 and 51 together engaging pin 61 with the new recess. This operation is repeated as needed. Also, although fixture 50 carries recesses 60 and fixture carries pin 61 in connection with joint 130, this can be reversed is previously explained.

FIGS. 15 and 15A show yet another embodiment of a joint designated generally at 150, including fixture 50, and fixture 51. Fixture 50 incorporates threaded bore 71, and fixture 51 incorporates bore 72, as previously explained in conjunction with the embodiment designated 20. With additional reference to FIG. 17, inner face 50A of fixture 50 supports teeth 151, and inner face 51A of fixture 51 supports complementing teeth 152, which are meshingly engagable with teeth 151 as shown in FIG. 17. In this embodiment, fixtures 50 and 51 are preferably integrally formed, such as through molding or machining, so as to incorporate teeth 151 and 152, respectively. In this embodiment, teeth 151 are arranged in a waffle pattern, and teeth 152 are arranged in a complementing waffle pattern, which permits teeth 152 to meshingly engage teeth 151 as shown in FIG. 17. FIG. 16 is an enlarged, fragmented perspective view of fixture 50 showing a detailed view of teeth 151. Teeth 152 are complement teeth 151, and have the same general structure of teeth 151.

To engage fixture 51 to fixture 50 in conjunction with the embodiment of joint 150, inner face 51A of fixture 51 is directed against inner face 50A of fixture 50 meshingly engaging teeth 152 of fixture 151 with teeth 151 of fixture 50. By meshingly engaging teeth 152 with teeth 151, fixture 51 is engaged/locked to fixture 50, in which the interaction of teeth 152 with teeth 151 functions to prevent fixture 51 from rotating relative to fixture 50. The provision of teeth 151 and 152 provide a potentially vast number of incrementally different engagement points for orienting frame member 22 in selected positions relative to frame member 21. To rigidly secure fixture 51 to fixture, a threaded fastener is passed through bore 72 through fixture 51 and threadably engaged to threaded bore 71. A threaded bolt, such as threaded bolt 70 discussed in conjunction with the embodiment designated at 20, can be used for this purpose. A handled threaded fastener can also be used for this purpose, such as the one designated at 155 in FIGS. 15 and 15A.

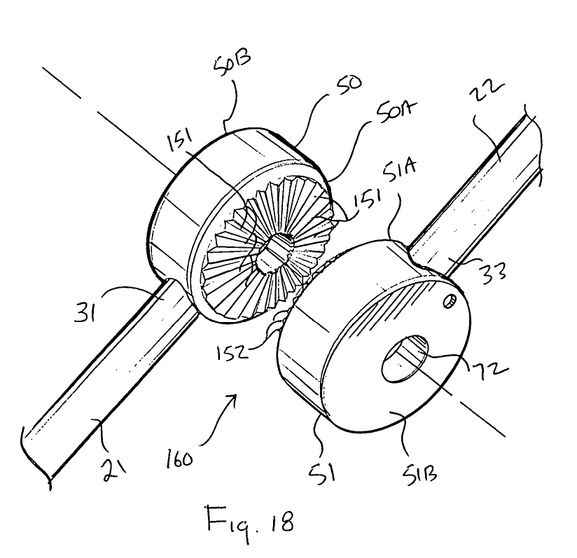

FIG. 18 shows yet a further embodiment of a joint designated generally at 160, including fixture 50, fixture 51, inner faces 50A and 51A, outer faces 50B and 51B, teeth 151 and complementing teeth 152. Joint 160 is substantially identical to joint 150, and the foregoing discussion of joint 150 applies to joint 160, with only one noted difference. In FIG. 18, teeth 151 and 152 are arranged in complementing radial patterns, in which teeth 151 and 152 radiate outwardly from central axes of fixtures 50 and 51, respectively. The embodiment depicted in FIG. 18 is instructive for showing a different pattern for teeth 151 and 152. It is to be understood that teeth 151 and 152 can be provided in any desired pattern complementing and meshingly-engagable patterns.

The present invention is described above with, reference to preferred embodiment. However, those skilled in the art will recognize that changes and modifications may be made in the described embodiments without departing from the nature and scope of the present invention. Various further changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A device for holding a roller for collecting and dispersing paint, comprising:
a first frame member having opposing first and second ends;
a second frame member having opposing first and second ends;
a handle attached to the first end of the first frame member;
a mandrel mounted for rotation to the first end of the second frame member; and
a joint coupling the second end of the first frame member to the second end of the second frame, wherein the joint is adjustable between a disengaged condition for selectively varying the angular displacement of the second frame member relative to the second frame member, and an engaged condition for securing the second frame member relative to the first frame member.

2. The device according to claim 1, further comprising:
the mandrel having a first end directed toward the first end of the second frame member, and an opposing second end; and
a counterweight; and
means for securing the counterweight to the second end of the mandrel.

3. The device according to claim 2, wherein the means for securing the counterweight to the second end of the mandrel includes a threaded fastener system having an element thereof carried by the counterweight and a complemental element thereof carried by the second end of the mandrel.

4. The device according to claim 1, further comprising a roller for collecting and dispersing paint attached to the mandrel.

5. The device according to claim 1, wherein the handle is parallel to the mandrel.

6. The device according to claim 1, wherein the handle is angularly offset relative to the mandrel.

7. A device for holding a roller for collecting and dispersing paint, comprising:
a first frame member;
a second frame member having a mandrel rotated thereto;
a first fixture affixed to one of the first frame member and the second frame member;
a second fixture affixed to the other of the first frame member and the second frame member;
means for mating the second fixture to the first fixture in a plurality of different orientations each corresponding to a different angular displacement of the second frame member relative to the first frame member.

8. The device according to claim 7, further comprising:
the mandrel having a first end directed toward the first frame member, and an opposing second end; and
a counterweight; and
means for securing the counterweight to the second end of the mandrel.

9. The device according to claim 8, wherein the means for securing the counterweight to the second end of the mandrel includes a threaded fastener system having an element thereof carried by the counterweight and a complemental element thereof carried by the second end of the mandrel.

10. The device according to claim 7, further comprising a roller for collecting and dispersing paint attached to the mandrel.

11. The device according to claim 7, wherein the handle is parallel to the mandrel.

12. The device according to claim 7, wherein the handle is angularly offset relative to the mandrel.

13. The device according to claim 7, wherein the means for mating the second fixture to the first fixture comprises teeth carried by a face of the second fixture and complementing teeth carried by an opposing face of the first fixture.

14. The device according to claim 7, wherein the means for mating the second fixture to the first fixture comprises:
an engagement element carried the second fixture; and
a plurality of complemental engagement elements carried by the first fixture each being an engagement point for the engagement element and defining a different angular displacement of the second frame member relative to the first frame member;
an engagement element including one of a male engagement element and a female engagement; and
the complemental engagement elements each including the other of the male engagement element and the female engagement element.

15. The device according to claim 14, further comprising a biasing mechanism biasing the male engagement toward the female engagement elements.

16. The device according to claim 7, further comprising means for tightening the second fixture against the first fixture.

17. The device according to claim 16, wherein the means for tightening the second fixture against the first fixture comprises a threaded fastener system having an element thereof carried by one of the first and second fixtures and a complemental element thereof carried by the other of the first and second fixtures.

18. In a device for holding a roller for collecting and dispersing paint including a frame having a first end, an opposing second end, a handle attached to the first end, and a rotating mandrel attached to the second end, improvements therein including a joint incorporated into the frame comprising:
a first fixture attached to a first portion of the frame, the first portion of the frame having the first end of the frame;
a second fixture attached to a second portion of the frame, the second portion of the frame having the second end of the frame;
means for mating the second fixture to the first fixture in a plurality of different orientations each corresponding to a different angular displacement of the second portion of the frame relative to the first portion of the frame.

19. The improvements according to claim 18, further comprising:
the mandrel having a first end directed toward the second portion of the frame, and an opposing second end; and
a counterweight; and
means for securing the counterweight to the second end of the mandrel.

20. The improvements according to claim 19, wherein the means for securing the counterweight to the second end of the mandrel includes a threaded fastener system having an element thereof carried by the counterweight and a complemental element thereof carried by the second end of the mandrel.

21. The improvements according to claim 18, wherein the handle is angularly offset relative to the mandrel.

22. The improvements according to claim 18, wherein the means for mating the second fixture to the first fixture comprises teeth carried by a face of the second fixture and complementing teeth carried by an opposing face of the first fixture.

23. The improvements according to claim 18, wherein the means for mating the second fixture to the first fixture comprises:
an engagement element carried the second fixture; and
a plurality of complemental engagement elements carried by the first fixture each being an engagement point for the engagement element and defining a different angular displacement of the second frame member relative to the first frame member;
an engagement element including one of a male engagement element and a female engagement; and
the complemental engagement elements each including the other of the male engagement element and the female engagement element.

24. The improvements according to claim 23, further comprising a biasing mechanism biasing the male engagement toward the female engagement elements.

25. The improvements according to claim 18, further comprising means for tightening the second fixture against the first fixture.

26. The improvements according to claim 25, wherein the means for tightening the second fixture against the first fixture comprises a threaded fastener system having an element thereof carried by one of the first and second fixtures and a complemental element thereof carried by the other of the first and second fixtures.
